(19) United States
(12) Patent Application Publication
(10) Pub. No.: US 2008/0164634 A1
(43) Pub. Date: Jul. 10, 2008

(54) METHODS OF FORMING A DOOR SKIN

(76) Inventors: David Kenneth Hodges, Malvern (GB); Vincent Conroy, Axminster (GB)

Correspondence Address: KING & SCHICKLI, PLLC, 247 NORTH BROADWAY, LEXINGTON, KY, 40507, US

(21) Appl. No.: 11/962,207

(22) Filed: Dec. 21, 2007

Related U.S. Application Data
(60) Provisional application No. 60/871,226, filed on Dec. 21, 2006.

(30) Foreign Application Priority Data
Dec. 23, 2006 (GB) 0625885.9

(51) Int. Cl. B29C 43/20

(52) U.S. Cl. 264/255

(57) ABSTRACT

According to the invention there is provided a method of forming a door skin including the steps of:
introducing a sheet moulding compound (SMC) into a mould;
moulding and at least partially curing the SMC to produce a skin having substantially the dimensions and external appearance of a door, and thereafter introducing an in-mould coating (IMC) composition to the mould;
causing, at least partially through applied pressure, the IMC composition to spread across a surface of the skin; and
curing the SMC composition to produce a cured door skin having a cured coating thereon.

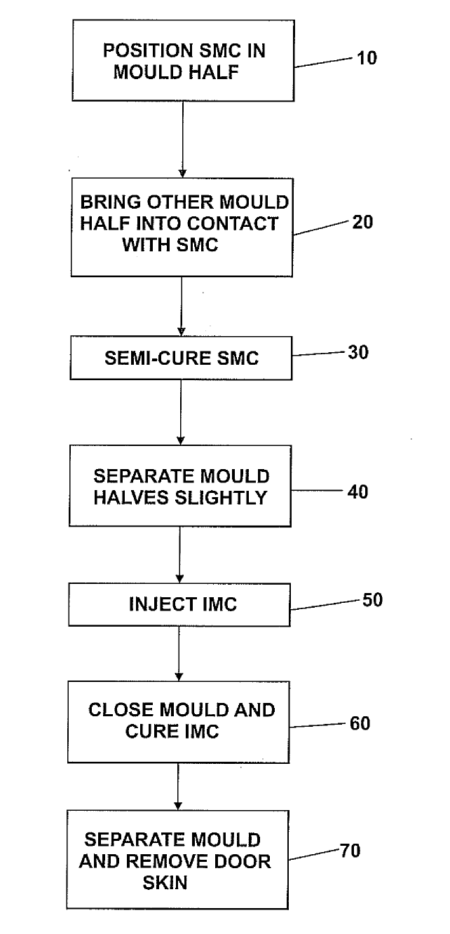

This application claims the benefit of U.S. Provisional Patent Application Ser. No. 60/871,226, filed Dec. 21, 2006.

This invention relates to methods of forming a door skin.

It is known from, for example, GB 2267529 to utilise pairs of plastic door skins in the manufacture of doors. The door skins are mounted on a frame, and panels of a suitable material are located within the frame between the door skins. In this way, doors are provided that are convenient and economical to manufacture. It is highly desirable to provide such doors with a suitable surface finish, which inter alia should have acceptable physical and aesthetic qualities. Typically, the finish coating is applied in a separate step after the moulding of the door skins. Such post-production treatments are generally undesirable, since they represent an extra and time consuming manufacturing step. It is known to mould door skins from sheet moulding compound (SMC) in a method in which powder is sprayed onto the mould part which is subsequently brought into contact with the SMC in order to produce a primer coating thereon. However, a subsequent finish paint coating is required. Furthermore, the process is costly, and can cause bowing of the door skin due to the different tensions that the skin is subjected to as a result of the process.

The present invention, in at least some of its embodiments, addresses the above described problems, and provides a convenient and cost effective way of providing a coating on a door skin.

According to the invention there is provided a method of forming a door skin including the steps of:

introducing a sheet moulding compound (SMC) into a mould;

moulding and at least partially curing the SMC to produce a skin having substantially the dimensions and external appearance of a door, and thereafter introducing an in-mould coating (IMO) composition to the mould;

causing, at least partially through applied pressure, the IMC composition to spread across a surface of the skin; and

curing the IMC composition to produce a cured door skin having a cured coating thereon.

In preferred embodiments, the IMC composition is curable to provide a top coat. By “top coat” it is meant that a finish is obtained that is at least equivalent to the finish obtained by applying a top coat of a suitable conventional paint to a cured door skin, and that it is not necessary to apply a further top coat to the door skin. It is most preferred that the IMC composition is curable to provide a high quality gloss finish. By “high quality gloss finish” it is meant that the cured IMC provides a finish at least equivalent to the finish provided by painting door skins with a conventional gloss paint in a typical prior art post-mould painting step.

Typically, the IMC composition is a thermosetting resin. Advantageously, the IMC composition includes a styrene monomer.

Preferably, the SMC is moulded by compression moulding. In such embodiments, the mould may include a pair of mould members and the compression moulding may include applying a pressure to the mould members, the step of introducing an IMC composition may include reducing the pressure applied to the pair of mould members and injecting the IMC composition into the mould; and the step of causing the IMC composition to spread across a surface of the skin may include increasing the pressure applied to the pair of mould members. The reduction in the pressure may cause a slight separation of the pair of mould members, and conversely the increase in the applied pressure during the step of causing the IMC composition to spread across a surface of the skin may act to close the mould by bringing the pair of mould members into contact. However, the separation under practical conditions is typically very small and is likely difficult or impossible to detect without specialist measurement techniques. Suitable IMC compositions are manufactured by Omnova Solutions, Inc, of Fairlawn, Ohio, USA under the trade name Stylecoat®. The Stylecoat® series 7100 IMC composition is particularly suited to compression moulding applications. Further IMC compositions and compression moulding techniques that may be used in the present invention can be found in EP 0854157, U.S. Pat. No. 4,552,913, U.S. Pat. No. 4,239,808 and U.S. Pat. No. 4,552,913.

In other embodiments, the SMC is moulded by injection moulding Stylecoat® series 8000 and 9000. IMC compositions are particularly suited to injection moulding applications. Further IMC compositions and injection moulding techniques that may be used in the present invention can be found in International Publication WO 2004/041503.

The invention is particularly suited for the convenient manufacture of door skins for use in the production of doors for buildings, such as houses or commercial buildings. The door skin may be rectangular.

Methods in accordance with the invention will now be described with reference to the accompanying drawing, which is a schematic diagram showing a method of the invention.

The invention comprises moulding a door skin from SMC, which has also been referred to GRP (glass reinforced plastic) or FRP (fibre reinforced plastic). In a typical embodiment, the SMC comprises two layers of a thermosetting resin, such as a polyester resin, which sandwich glass fibres of an appropriate size, e.g. around 25 mm. Typically, the glass fibre comprises 20 to 45% of the SMC compound (by weight). As represented at 10 in the drawing, the SMC is positioned in a mould halt. As indicated at 20, the other mould half is brought into contact with the SMC, the two mould halves defining a mould cavity corresponding to the desired shape of the door skin. Typically this is a rectangular shape of dimensions suitable for domestic use. The door skin may have decorative panels and recesses formed therein as desired. The second mould half is attached to a hydraulic press or otherwise equipped so as to apply a suitable pressure to the SMC. Representative pressures are in the range 4-1400 tonnes. Furthermore, the mould is provided with heating means to enable the mould temperature to be set so as to enable the thermosetting resin in the SMC to semi-cure under the conditions of temperature and pressure, as depicted as 30.

As depicted at 40, once the thermosetting resin in the SMC has semi-cured to an acceptable extent, the applied pressure is relaxed, and the mould halves are caused to separate slightly. As depicted at 50, IMC is then injected into the mould cavity at high pressure using an injection nozzle provided in the second mould so that a charge of IMC is present in the mould cavity between the second mould half and a face of the semi-cured SMC. As depicted at 60, the mould halves are brought into contact so as to close the mould, and pressure is reapplied to the SMC. This pressure causes the IMC to be spread over the face of the SMC directly underneath the second mould half, thereby producing a coating thereon. The IMC is a thermosetting resin which is cured under the heat and pressure conditions utilised. Additionally, the SMC is fully cured under these conditions. Subsequently, as shown at 70, the mould halves are separated and the cured door skin, having a cured surface coating thereon, is removed from the mould.

The process of the invention is convenient and economical. A further benefit of manufacturing door skins using SMC and IMC is that both of these elements cross-link to provide a very strong bond, thereby providing a robust coating. This is advantageous, since the doors eventually produced from such door skins are frequently subjected to external stresses through mistreatment and abuse. Particularly preferred examples of IMCs comprise the Stylecoat® series 7100 IMCs produced by Omnova Solutions Inc. Door skins having high quality top coatings may be provided using the in mould coating technique of the present invention which do not require a further, post-mould coating treatment.

There are numerous variations that are within the scope of the invention. For example, it is possible to cause relative lateral motion of the mould halves in order to assist in the spreading of the IMC across the surface of the semi-cured door skin. Although it is preferred that compression moulding is utilised to produce the door skin, it is possible to utilise another moulding technique such as injection moulding.

1. A method of forming a door skin including the steps of: introducing a sheet moulding compound (SMC) into a mould;
moulding and at least partially curing the SMC to produce a skin having substantially the dimensions and external appearance of a door, and thereafter introducing an in-mould coating (IMC) composition to the mould;
causing, at least partially through applied pressure, the IMC composition to spread across a surface of the skin; and
curing the SMC composition to produce a cured door skin having a cured coating thereon.

2. A method according to claim 1 in which the IMC composition is curable to provide a top coat.

3. A method according to claim 1 in which the IMC composition is a thermosetting resin.

4. A method according to claim 3 in which the IMC composition includes a styrene monomer.

5. A method according to claim 1 in which the SMC is moulded by compression moulding.

6. A method according to claim 5 in which:
the mould includes a pair of mould members and the compression moulding includes applying a pressure to the mould members; the step of introducing an IMC composition includes slightly reducing the pressure applied to the mould members and injecting the IMC composition into the mould;
and the step of causing the IMC composition to spread across a surface of the skin includes increasing the pressure applied to the mould members.

7. A method according to claim 1 in which the SMC is moulded by injection moulding.

8. A method according to claim 1 in which the door skin is rectangular.

9. (canceled)

10. A method according to claim 2 in which the IMC composition is a thermosetting resin.

11. A method according to claim 10 in which the IMC composition includes a styrene monomer.

12. A method according to claim 2 in which the SMC is moulded by compression moulding.

13. A method according to claim 3 in which the SMC is moulded by compression moulding.

14. A method according to claim 4 in which the SMC is moulded by compression moulding.

15. A method according to claim 2 in which the SMC is moulded by injection moulding.

16. A method according to claim 3 in which the SMC is moulded by injection moulding.

17. A method according to claim 4 in which the SMC is moulded by injection moulding.

18. A method according to claim 2 in which the door skin is rectangular.

19. A method according to claim 3 in which the door skin is rectangular.

20. A method according to claim 4 in which the door skin is rectangular.
